(19) United States
(12) Patent Application Publication
(10) Pub. No.: US 2026/0145877 A1
(43) Pub. Date: May 28, 2026

(54) CONVEYOR FOR CONTAINER TRANSPORT AND ASSOCIATED METHOD

(71) Applicant: KRONES AG, Neutraubling (DE)

(72) Inventor: Bruno LANDLER, Neutraubling (DE)

(21) Appl. No.: 19/400,907

(22) Filed: Nov. 25, 2025

(30) Foreign Application Priority Data
Nov. 26, 2024 (DE) 10 2024 134 762.7

(51) Int. Cl. B65G 17/12; B65G 23/44; B65G 49/00

(52) U.S. Cl. CPC B65G 17/12; B65G 23/44; B65G 49/00; B65G 2201/0252

(57) ABSTRACT

The invention relates, inter alia, to a conveyor for container transport for a container treatment facility. The conveyor has a circulating transport element and a plurality of carriers which are arranged at a distance from one another along the circulating transport element and are attached to the circulating transport element for carrying containers along. The conveyor further comprises a cleaning fluid line for conducting cleaning fluid, a plurality of spray devices connected to the cleaning fluid line for spraying the cleaning fluid, and a main longitudinal beam which carries the circulating transport element and the cleaning fluid line.

### TECHNICAL FIELD

The invention relates to a conveyor for container transport, to a container treatment facility with a conveyor and to an associated method.

### TECHNICAL BACKGROUND

The use of conveyors in a container treatment facility in order to transport containers between different machines in the facility is known.

For example, in a filler-capper block, the filler may have a different machine pitch than the capper. A conveyor chain with carriers can connect the filler and the capper to transport the containers from the filler to the capper.

DE 10 2020 116 779 A1 relates to a filling machine for filling cans or similar containers with a liquid filling material. In this case, the container treatment apparatus comprises a first conveyor configured as a container infeed, a rotor arranged downstream in the treatment direction and circulating about a machine shaft with a plurality of treatment positions for treating the containers, and a second conveyor arranged downstream of the rotor in the treatment direction and configured as a container outlet. In this case, the second conveyor is configured as a chain conveyor which has at least one guide finger on a continuously circulating conveyor means, which finger moves with the conveyor means and has a first and a second guide portion which takes over the containers which have been treated at the plurality of treatment positions of the rotor and are not yet closed.

A disadvantage of the known prior art may be its lack of suitability for particularly hygienic applications, e.g., under clean room conditions.

The invention is based on the object of providing an improved technique for transporting containers, with which even high hygiene requirements, e.g., in clean rooms, can be met.

### SUMMARY OF THE INVENTION

The object is achieved by the features of the independent claims. Advantageous developments are specified in the dependent claims and the description.

One aspect relates to a conveyor for container transport, preferably for can transport, for a container treatment facility. The conveyor has a circulating transport element, preferably a transport chain. The conveyor has a plurality of carriers, preferably cantilever arms or contact fingers. The multiple carriers are arranged spaced apart from one another along the circulating transport element and are attached (e.g., rigidly) to the circulating transport element for carrying containers along, preferably one container at a time. The conveyor has a cleaning fluid line for conducting cleaning fluid and a plurality of spray devices connected to the cleaning fluid line for spraying the cleaning fluid (e.g., in and/or onto the conveyor). The conveyor has a, preferably tubular (e.g., single), main longitudinal beam which carries the circulating transport element and the cleaning fluid line (e.g., via booms, etc.).

The conveyor can also advantageously meet high hygiene requirements. The use of a solid main longitudinal beam to carry the attachments, etc., eliminates the need to use one or more cleaning fluid lines for carrying attachments (e.g., via pipe clamps, etc.). Even very hot cleaning fluid (e.g. ≥80° C.) can be passed through the cleaning fluid line, because the heat-induced expansion of the cleaning fluid line is unproblematic for the supporting structure of the conveyor due to the presence of the main longitudinal beam. Advantageously, this also makes it possible to clean the conveyor with the very hot cleaning fluid, which improves the cleaning effect and thus hygiene. The solid main longitudinal beam can thus advantageously minimize the effects of cold/warm phases during cleaning or, for example, hot filling.

In one exemplary embodiment, the cleaning fluid line is mounted in a floating, preferably longitudinally displaceable manner with respect to the main longitudinal beam, preferably to compensate for heat-induced longitudinal expansion of the cleaning fluid line. Preferably, the cleaning fluid line can be mounted in a floating (preferably longitudinally displaceable) manner relative to the main longitudinal beam via at least one hook element, and/or the cleaning fluid line can be mounted in a floating (preferably longitudinally displaceable) manner on (at least) one boom which is connected (e.g., directly) to the main longitudinal beam (e.g., via a hook element in each case). The floating mounting can advantageously allow the cleaning fluid line to be supplied with comparatively hot cleaning fluid (e.g. ≥80° C.), which can improve the cleaning effect and hygiene. The substantial longitudinal expansion of the cleaning fluid line caused by the hot cleaning fluid can be advantageously accommodated by the floating mounting.

Preferably, the cleaning fluid line can be connected to a heating device for heating the cleaning fluid.

In a further exemplary embodiment, the conveyor further comprises a transfer plate over which the containers can be pushed while being carried along by the carriers. The transfer plate is supported by the main longitudinal beam. This can advantageously enable faster and reliable transport of the containers. Advantageously, the main frame component, namely the main longitudinal beam, can again be used to support the transfer plate, resulting in a simple and stable construction which is unaffected by any longitudinal expansion of the cleaning fluid line.

In one embodiment, the transfer plate is mounted in a floating, preferably longitudinally displaceable manner with respect to the main longitudinal beam, preferably to compensate for heat-induced longitudinal expansion of the transfer plate. Preferably, the transfer plate can be mounted in a floating (preferably longitudinally displaceable) manner relative to the main longitudinal beam using (at least) one fastening-element-to-elongated-hole connection, and/or the transfer plate can be mounted in a floating (preferably longitudinally displaceable) manner on (at least) one (e.g., further) boom which is connected (e.g., directly) to the main longitudinal beam (e.g., in each case via a fastening-element-to-elongated-hole connection). The floating mounting can advantageously allow the transfer plate to be cleaned with the comparatively hot cleaning fluid (e.g. ≥80° C.), which can improve the cleaning effect and hygiene. The substantial longitudinal expansion of the transfer plate caused by the hot cleaning fluid can be advantageously accommodated by the floating mounting.

For example, the fastening-element-to-elongated-hole connection can have at least one fastening element and at least one elongated hole of a mounting plate in which the at least one fastening element is guided in a longitudinally displaceable manner.

In a further embodiment, the transfer plate extends substantially along an entire conveying path of the conveyor, and/or the transfer plate has a plurality of (e.g., flush) transfer plate segments which are aligned with one another, preferably flush.

In one embodiment variant, the conveyor further comprises a drive pulley for driving the transport element, wherein the transport element is placed around the drive pulley, preferably over an angular range of 180° of the drive pulley. Preferably, the conveyor can further comprise a drive source which is drivingly connected to the drive pulley, and optionally a sealed housing in which the drive source is arranged. Advantageously, the sealed housing can allow the conveyor to be cleaned particularly thoroughly, for example using splashing cleaning fluid and steam generation, because there is no risk of damaging the drive source.

In a further embodiment variant, the sealed housing has at least one access opening, preferably an upper access opening and a side access opening, which is covered by a removable cover and sealed with a, preferably annular, sealing element (e.g., O-ring). Alternatively or additionally, the sealed housing can be placed on a machine table (e.g., a closure apparatus) in a sealed manner, for example via a sealing element. Advantageously, the access opening(s) can allow for, for example, easy assembly and disassembly of a drive shaft for driving the drive pulley without reducing the hygiene requirements. The sealed arrangement of the removable cover(s) and of the housing on the machine table ensures that, for example, no cleaning fluid penetrates into the housing from below and reaches the drive source.

In one exemplary embodiment, the conveyor further comprises a main deflection wheel for deflecting the circulating transport element. The circulating transport element is placed around the main deflection wheel, preferably over an angular range of 180° of the main deflection wheel. The main deflection wheel is arranged at one end of the conveyor. Advantageously, by using a main deflection wheel, the use of conventional sliding profiles for deflecting the transport element can be dispensed with. A disadvantage of these conventional sliding profiles can be their significant lubrication requirement, which can be substantially reduced by the main deflection wheel. This can also advantageously improve hygiene.

In a further exemplary embodiment, the conveyor further comprises a, preferably active, tensioning device for tensioning the circulating transport element. The main deflection wheel can be moved longitudinally by the tensioning device for tensioning the circulating transport element. Advantageously, the tensioning device can always keep the circulating transport element under the correct tension. This is important to ensure smooth and efficient operation of the conveyor.

In one embodiment, the tensioning device is carried on the main longitudinal beam, preferably at one end of the main longitudinal beam. Alternatively or additionally, the tensioning device can be a pneumatic tensioning device. Alternatively or additionally, the tensioning device can have a, preferably pneumatic, pressure cylinder which acts on the main deflection wheel to extend along a longitudinal axis of the conveyor in order to tension the circulating transport element. Advantageously, the main frame component, namely the main longitudinal beam, can again be used to support the tensioning device, resulting in a simple and stable construction which is unaffected by any longitudinal expansion of the cleaning fluid line. Continuous actuation of the deflection wheel advantageously allows for an active system which automatically extends during operation of the conveyor, for example in the event of chain elongation, in order to prevent the transport element from sagging.

In a further embodiment, the conveyor further comprises a position sensor for detecting a position of the tensioning device and/or the main deflection wheel. Preferably, the conveyor can further comprise a control device which is configured to monitor a functionality of the circulating transport element depending on a signal output of the position sensor. Advantageously, excessive elongation or a (e.g., partial) crack in the transport element can thus be automatically detected.

Preferably, the term “control device” can refer to an electronic system (e.g., embodied as a driver circuit or with microprocessor(s) and data memory) and/or a mechanical, pneumatic, and/or hydraulic controller, which can take over open-loop control tasks and/or closed-loop control tasks and/or processing tasks, depending on the configuration. Although the term “control” is used herein, this can also comprise or be understood as “closed-loop control” or “control with feedback” and/or “processing” as appropriate. The control device can, for example, be a central control device or have a plurality of decentralized or distributed control units.

In one embodiment variant, the conveyor further comprises at least one secondary deflection wheel for deflecting the circulating transport element. Preferably, the circulating transport element can be placed around the at least one secondary deflection wheel (e.g., in an angular range ≤90° or ≤60°). Preferably, the at least one secondary deflection wheel can be arranged in a return portion of the conveyor (e.g., on the lower run) for returning the circulating transport element. Preferably, the at least one secondary deflection wheel can change, preferably increase, a height level of the circulating transport element. Advantageously, by using at least one secondary deflection wheel, the use of conventional sliding profiles for deflecting the transport element can be dispensed with. As already mentioned, a disadvantage of these conventional sliding profiles can be their significant lubrication requirement, which can be substantially reduced by the at least one secondary deflection wheel. This can also advantageously improve hygiene.

In one exemplary embodiment, at least one of the following is fulfilled:
the main longitudinal beam is arranged centrally in the conveyor with respect to a transverse axis of the conveyor;
the main longitudinal beam is arranged between an upper run and a lower run of the conveyor;
the main longitudinal beam extends substantially along an entire length of the conveyor;
the main longitudinal beam has a plurality of main longitudinal beam segments which are aligned with one another, preferably flush;
the main longitudinal beam is arranged at a height offset from, preferably above, the cleaning fluid line;
the main longitudinal beam is the only main longitudinal beam of the conveyor;
the conveyor has no further main longitudinal beam parallel to the main longitudinal beam;
the main longitudinal beam is not a fluid-conducting pipeline element;
the cleaning fluid line runs substantially parallel to the main longitudinal beam; and
the conveyor is free of stationary sliding profiles for deflecting the circulating transport element.

A further aspect relates to a container treatment facility (e.g., for controlling the temperature of, producing, cleaning, coating, testing, filling, closing, pasteurizing, decorating, labeling, printing, marking, laser marking, and/or packaging containers for liquid or pasty media, preferably beverages, liquid foods, or products from the pharmaceutical or healthcare industry), preferably to a can treatment facility. The container treatment facility comprises a first apparatus, preferably a filling apparatus, for filling containers, a second apparatus, preferably a closure apparatus, for closing the containers, and a conveyor as disclosed herein. The conveyor is connected (e.g., directly) to the first apparatus for receiving the containers from the first apparatus and (e.g., directly) to the second apparatus for transferring the received containers to the second apparatus. Preferably, the conveyor and/or the first apparatus and/or the second apparatus can be arranged in a clean room. The conveyor can therefore advantageously be used for the direct connection/blocking of the filling apparatus and the closure apparatus, preferably under clean room conditions.

For example, the containers can be realized as bottles, cans, canisters, cartons, vials, tubes, etc.

A further aspect relates to a method for operating a conveyor as disclosed herein or a container treatment facility as disclosed herein, e.g., during cleaning operation. The method comprises the following:
supplying a heated cleaning fluid (e.g., at a cleaning fluid temperature ≥50° C., ≥60° C., ≥70° C. or ≥80° C.) to the cleaning fluid line; and
spraying the supplied heated cleaning fluid via the plurality of spray devices (e.g., onto an upper side of the conveyor and/or from within the conveyor).

Preferably, the method can further comprise at least one of the following:
compensating for longitudinal expansion of the cleaning fluid line caused by the heated cleaning fluid by floatingly mounting the cleaning fluid line relative to the main longitudinal beam;
compensating for longitudinal expansion of a transfer plate caused by the heated cleaning fluid, over which containers are pushed by the carriers, by floatingly mounting the transfer plate relative to the main longitudinal beam; and
sealing a drive source of the conveyor against the heated cleaning fluid by a sealed housing in which the drive source is arranged.

Advantageously, the method can achieve the same advantages as already described with reference to the apparatus.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a schematic representation of a container treatment facility with a conveyor according to an exemplary embodiment;

FIG. 2 shows a perspective view of an exemplary conveyor;

FIG. 3 shows a perspective view of a portion of the exemplary conveyor;

FIG. 4 shows a perspective view of a further portion of the exemplary conveyor;

FIG. 5 shows a perspective view of a portion of the exemplary conveyor in the region of a drive pulley of the exemplary conveyor;

FIG. 6 shows a perspective sectional view of a portion of the exemplary conveyor in the region of a drive source of the exemplary conveyor; and

FIG. 7 shows a perspective view of a portion of the exemplary conveyor in the region of a main deflection wheel of the exemplary conveyor.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

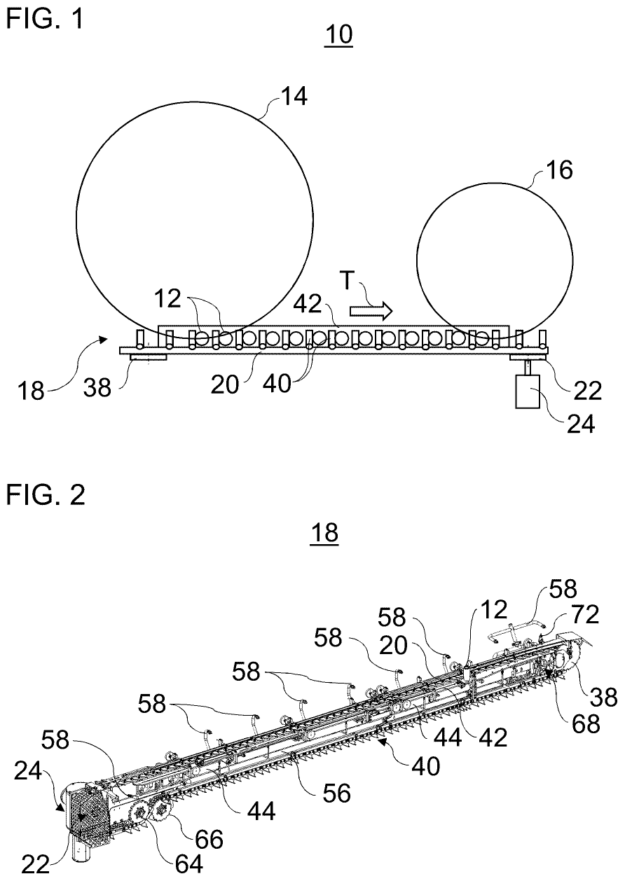

FIG. 1 shows a container treatment facility 10 for treating containers 12 (only a few shown in FIG. 1). Preferably, the containers 12 take the form of cans, or the container treatment facility 10 is a can treatment facility.

The container treatment facility 10 has a conveyor 18 for transporting the containers 12. The container treatment facility 10 can further comprise, for example, a filling apparatus 14 and/or a closure apparatus 16.

The filling apparatus 14 can fill the containers 12, preferably with a liquid or pasty medium. The filling apparatus 14 is preferably embodied as a rotary filling apparatus. The filling apparatus 14 can comprise a plurality of filling stations for filling a plurality of containers 12 simultaneously or overlapping in time. For example, the filling stations can be arranged distributed around a periphery of a filler carousel of the rotary filling apparatus.

The closure apparatus 16 can seal the containers 12, for example with a lid, a cork, a crown cap or a screw cap. The closure apparatus 16 can preferably be embodied as a rotary closure apparatus. The closure apparatus 16 can have a plurality of closure stations for closing a plurality of containers 12 either simultaneously or with a temporal overlap. For example, the closure stations can be arranged distributed around a periphery of a closure carousel of the rotary closure apparatus. The closure apparatus 16 can be arranged downstream of the filling apparatus 14 in relation to a container stream.

Preferably, the filling apparatus 14, the closure apparatus 16 and/or the conveyor 18 can be arranged in an isolator/clean room.

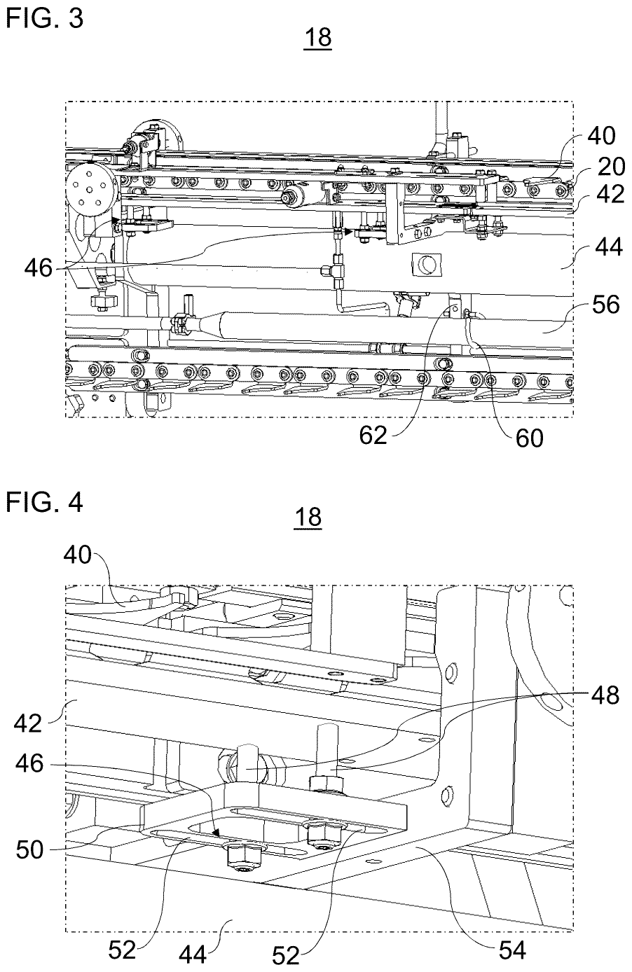

The conveyor 18 is explained below generally with reference to FIG. 1 and, in a particularly preferred embodiment, with reference to FIGS. 2 to 7, which show an exemplary conveyor 18 substantially completely (FIG. 2) and in sections (FIGS. 3 to 7).

The conveyor 18 can transport the containers 12 in a transport direction T, for example from the filling apparatus 14 to the closure apparatus 16. The conveyor 18 can connect the filling apparatus 14 and the closure apparatus 16 to each other, preferably directly, for transporting containers 12 from the filling apparatus 14 to the closure apparatus 16.

The conveyor 18 can be connected to the filling apparatus 14 for receiving containers 12 from the filling apparatus 14, preferably directly. The conveyor 18 can be connected to the closure apparatus 16, preferably directly, for transferring the received containers 12 to the closure apparatus 16.

It is also possible that the conveyor 18 does not receive the containers 12 directly from the filling apparatus 14 but rather for example from an outlet starwheel which is directly connected to the filling apparatus 14. It is also possible that the conveyor 18 does not transfer the containers 12 directly to the closure apparatus 16 but for example to an infeed starwheel which is directly connected to the closure apparatus 16.

The conveyor 18 can have lateral guide rails for laterally guiding the transported containers 12.

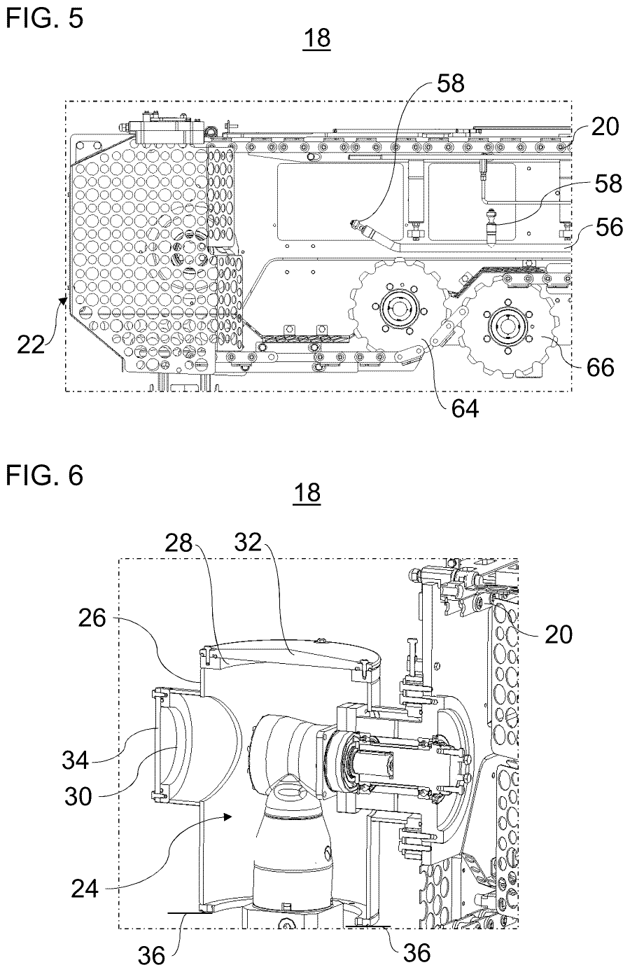

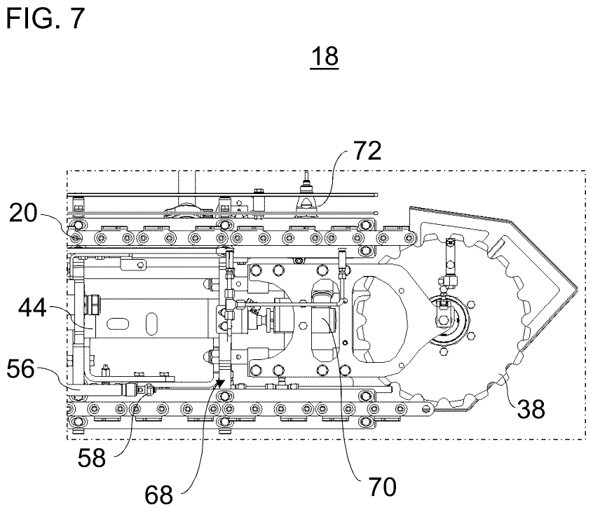

The conveyor 18 has a circulating transport element 20 and a plurality of (for example, can) carriers 40. The conveyor 18 further comprises a main longitudinal beam 44 (see FIGS. 2, 3, 4 and 7) and a cleaning fluid line 56 (see FIGS. 2, 3 and 5). The conveyor 18 can, for example, also have a drive pulley 22 (see FIGS. 1, 2 and 5), a drive source 24 (see FIGS. 1, 2 and 6), a main deflection wheel 38 (see FIGS. 1, 2 and 7), a transfer plate 42 (see FIGS. 1 to 4), at least one secondary deflection wheel 64, 66 (see FIGS. 2 and 5) and/or a tensioning device 68 (see FIGS. 2 and 7).

The transport element 20 can be a closed transport element or a continuous transport element. The transport element 20 can, for example, circulate about the drive pulley 22 and the main deflection wheel 38. Preferably, the transport element 20 is a transport chain. The transport element 20 can transport the containers 12 via the carrier 40.

The drive pulley 22 can be drivingly connected to the circulating transport element 20. The transport element 20 can be placed around the drive pulley. Preferably, the drive pulley 22 can be placed around the drive pulley 22 over an angular range of approximately 180° (e.g., with respect to a central axis of the drive pulley 22). Preferably, the drive pulley 22 has a horizontally oriented axis of rotation.

For example, the drive pulley 22 can be as a drive pinion in engagement with the circulating transport element 20. Preferably, the drive pulley 22 can be a drive sprocket in engagement with the transport element 20 embodied as a transport chain.

Preferably, the drive pulley 22 is arranged at an end of the conveyor 18 associated with the closure apparatus 16. Preferably, the containers 12 are transferred from the conveyor 18 to the closure apparatus 16 in the region of the drive pulley 22 or directly adjacent thereto. Alternatively, the drive wheel 22 can be arranged at a different position of the conveyor 18, e.g., at an end of the conveyor 18 associated with the filling apparatus 14.

The drive source 24 can be drivingly connected to the drive pulley 22. The drive source 24 can preferably be designed as an electric motor. The drive source 24 can, for example, be connected directly or via a transmission to the drive pulley 22 for driving the drive pulley 22.

Preferably, the drive source 24 can be arranged in a sealed housing 26 (see FIG. 6). The housing 26 can preferably have an upper access opening 28 and/or a side access opening 30.

The upper access opening 28 can be covered by means of a removable cover 32. For example, the cover 32 can be releasably screwed to the housing 26. At least one, preferably annular, sealing element can connect the cover 32 to the housing 26 in a sealed manner.

The side access opening 30 can be covered by means of a removable cover 34. For example, the cover 34 can be removably screwed to the housing 26. At least one, preferably annular, sealing element can connect the cover 34 to the housing 26 in a sealed manner.

Preferably, the housing 26 can be placed on a machine table 36 (only schematically indicated in FIG. 6) in a sealed manner via a sealing element. Preferably, the machine table 36 is a machine table of the closure apparatus 16 (see FIG. 1).

During cleaning operation of the conveyor 18, the housing 26 can accordingly protect the drive source 24 from the cleaning fluid.

The main deflection wheel 38 can be connected to the transport element 20 for deflecting the transport element 20. The transport element 20 can be placed around the main deflection wheel. Preferably, the transport element 20 can be placed around the main deflection wheel 38 over an angular range of 180° (e.g., with respect to a central axis of the main deflection wheel 38). Preferably, the main deflection wheel 38 has a horizontally oriented axis of rotation.

For example, the main deflection wheel 38 can be a deflection pinion in engagement with the circulating transport element 20. Preferably, the main deflection wheel 38 can be a deflection sprocket (idler sprocket) in engagement with the transport element 20 embodied as a transport chain.

The main deflection wheel 38 can be arranged at an end region of the conveyor 18. The main deflection wheel 38 can deflect the transport element 20, for example, back to the drive pulley 22. Preferably, the main deflection wheel 38 is arranged at an end of the conveyor 18 associated with the filling apparatus 14. Preferably, the containers 12 are transferred from the filling apparatus 14 to the conveyor 18 in the region of the main deflection wheel 38 or directly adjacent thereto. Alternatively, the main deflection wheel 38 can be arranged at a different position of the conveyor 18, e.g., at an end of the conveyor 18 associated with the closure apparatus 16.

Preferably, the drive pulley 22 and the main deflection wheel 38 can be arranged at opposite ends of the conveyor 18.

The carriers 40 can transport the containers 12 or carry them along. Preferably, each carrier 40 can in each case transport (only) one of the containers 12. The carriers 40 can support the containers 12 at the rear for transport.

Preferably, the carriers 40 can be configured as cantilever arms or contact fingers. The cantilever arms can span the transfer plate 42 transversely to the transport direction of the conveyor 18.

For example, the carriers 40 can each have a recess (pocket) for a container 12. The recess can, for example, be in the shape of a cylinder shell segment. The recess can be arranged on a side of the particular carrier 40 facing in the transport direction T of the conveyor 18.

The carriers 40 are arranged spaced apart from one another along the circulating transport element 20. The carriers 40 can preferably be arranged equidistant from each other along the transport element 20. For example, the carriers 40 can be arranged laterally next to the circulating transport element 20.

A distance between adjacent carriers 40 can also be referred to as a so-called pitch/machine pitch or a so-called pitch distance (for container transport). The pitch can, for example, be in a range between 70 mm and 110 mm.

The carriers 40 are attached to the transport element 20 for carrying the containers 12 along, e.g., directly or indirectly. Preferably, the circulating transport element 20 carries the carriers 40.

For example, the carriers 40 can push the containers 12 over the (stationary) transfer plate 42 of the conveyor 18. Preferably, the carriers 40 can be positioned in the region of the pulling strand (working strand) of the transport element 20, above and vertically spaced apart from the transfer plate 42.

The transfer plate 42 can extend substantially along an entire conveying path of the conveyor 18. The transfer plate 42 can preferably extend from the filling apparatus 14 to the closure apparatus 16. The transfer plate 42 can support the containers 12 on their base side during transport.

For example, the transfer plate 42 can have a plurality of transfer plate segments. The transfer plate segments are preferably aligned with each other. The upper sides of the transfer plate segments are preferably in a common plane or are flush with each other.

As an alternative to the transfer plate 42, the containers 12 can be supported on the bottom side, for example on a revolving support element, for example a belt or a mat chain, of the conveyor 18, while the containers 12 are each supported on the periphery (lateral face/rear side) by the carriers 40 (not shown). It is possible that the circulating support element is connected to the transport element 20 for driving by the transport element 20.

The main longitudinal beam 44 of the conveyor 18 can support various components and attachments of the conveyor 18, e.g., directly or via brackets and booms (see, for example, FIGS. 2, 3, 4 and 7). The core function of the main longitudinal beam 44 can be to support other components and parts. Accordingly, the main longitudinal beam 44 cannot be a fluid-conducting pipeline element.

The main longitudinal beam 44 can be the main part of a support frame/support structure of the conveyor 18. The conveyor 18 preferably has no further main longitudinal beam parallel to the main longitudinal beam 44. Preferably, the main longitudinal beam 44 is the only main longitudinal beam of the conveyor 18.

For example, the main longitudinal beam 44 can be supported on a floor via support legs (not shown) of the conveyor 18. It is possible that substantially all components of the conveyor 18 are supported on the support legs via the main longitudinal beam 44 (exception, for example: drive source 24 and housing 26).

Preferably, the main longitudinal beam 44 may extend substantially along an entire length of the conveyor 18. For example, the main longitudinal beam 44 can extend approximately from the filling apparatus 14 to the closure apparatus 16.

Preferably, the main longitudinal beam 44 is tubular. For example, the main longitudinal beam 44 may have a wall thickness ≥15 mm, ≥20 mm or ≥25 mm. The tube shape can, for example, have a round (e.g., circular) or polygonal (e.g., square) cross section.

The main longitudinal beam 44 can preferably be arranged inside the conveyor 18. For example, the main longitudinal beam 44 can be arranged centrally in the conveyor 18 with respect to a transverse axis of the conveyor 18. For example, the main longitudinal beam 44 can be arranged between an upper run and a lower run of the conveyor 18. For example, the main longitudinal beam 44 can be arranged between the two longitudinal outer sides of the conveyor 18. For example, the main longitudinal beam 44 can be arranged at a height offset from, preferably above, the cleaning fluid line 56.

For example, the main longitudinal beam 44 has a plurality of main longitudinal beam segments. The main longitudinal beam segments can be arranged side by side along a common longitudinal axis. The main longitudinal beam segments can preferably be aligned flush with each other. The main longitudinal beam segments can preferably be fastened to one another at the ends, e.g., detachably (e.g., by screw connection(s)).

The main longitudinal beam 44 carries the cleaning fluid line 56 and the optional transfer plate 42. The main longitudinal beam 44 can, for example, carry guide railings and other components and parts of the conveyor 18 via booms, brackets, etc.

As shown by way of example in FIG. 4, the transfer plate 42 can preferably be mounted in a floating, preferably longitudinally displaceable manner with respect to the main longitudinal beam 44. Preferably, heat-induced longitudinal expansion of the transfer plate 42 caused, for example, by heated cleaning fluid during cleaning operation or by friction or hot containers during normal operation can be compensated for by floatingly mounting the transfer plate 42, i.e., be accommodated by the floating mounting.

The floating mounting can preferably be provided at a plurality of mounting points along the transfer plate 42. The longitudinal displaceability can preferably exist with respect to a longitudinal axis of the conveyor 18.

In detail, a floating mounting can be realized by a fastening-element-to-elongated-hole connection 46. Preferably, a plurality of fastening-element-to-elongated-hole connections 46 are provided, which are, for example, spaced apart from one another along a longitudinal axis of the transfer plate 42 and/or along a longitudinal axis of the main longitudinal beam 44.

The fastening-element-to-elongated-hole connection 46 can have at least one fastening element 48, such as a screw or a pin, and a mounting plate 50 with at least one elongated hole 52. A longitudinal axis of the at least one elongated hole 52 may be substantially parallel to a longitudinal axis of the conveyor 18. The at least one fastening element 48 can be inserted through the at least one elongated hole 52 and, for example, screwed into the transfer plate 42 from below or otherwise attached to the transfer plate 42. The at least one fastening element 48 can be displaceably guided along the at least one elongated hole 52 for the floating mounting of the transfer plate 42 on the mounting plate 50.

The mounting plate 50 can, for example, be attached to a boom 54, which in turn can be attached to the main longitudinal beam 44. The main longitudinal beam 44 can support the transfer plate 42 via the boom 54, the mounting plate 50 and the at least one fastening element 48. The at least one fastening element 48 can preferably be supported on the mounting plate 50, e.g., by a nut.

The boom 54 can be connected to the main longitudinal beam 44, for example, detachably, e.g., by screw connection(s), or non-separably, e.g., by welding. Preferably, the boom 54 can extend with its main extension direction transversely to a longitudinal axis of the main longitudinal beam 44.

For example, the mounting plate 50 can have two parallel elongated holes 52. A fastening element 48 can extend through each elongated hole 52.

The cleaning fluid line 56 serves to conduct cleaning fluid (see FIGS. 2, 3 and 5). The cleaning fluid line 56 can be connected, for example, to a cleaning fluid source, preferably to a cleaning liquid source. The cleaning fluid source can preferably provide at least one heated cleaning liquid, e.g., water and/or cleaning foam or, when sprayed, foam-forming cleaning liquid.

Preferably, the cleaning fluid line 56 can run substantially parallel to the main longitudinal beam 44. The cleaning fluid line 56 can extend along a length of the conveyor 18, e.g., from the filling apparatus 14 to the closure apparatus 16.

The cleaning fluid line 56 is connected to a plurality of spray devices 58, e.g., each having a spray nozzle. Cleaning fluid can be supplied to the plurality of spray devices 58 via the cleaning fluid line 56. The spray devices 58 can spray the cleaning fluid, e.g., onto an upper side of the conveyor 18 and within the conveyor 18. Preferably, the spray devices 58 are arranged distributed along the conveyor 18.

During cleaning operation of the conveyor 18, a heated cleaning fluid (e.g., cleaning liquid) can then be supplied from the cleaning fluid source to the cleaning fluid line 56. The heated cleaning fluid can, for example, have a cleaning fluid temperature of ≥50° C., ≥60° C., ≥70° C. or ≥80° C. The spray devices 58 can then spray this cleaning fluid to clean the conveyor 18.

Preferably, at least one spray device 58 can be arranged between an upper run of the transport element 20 and a lower run of the transport element 20. At least one spray device 58 can, for example, only be directed towards the lower run. Alternatively or additionally, at least one spray device 58 may be directed towards the upper run.

Preferably, at least one spray device 58 can be directed onto an upper side or container conveyor side/container support side of the conveyor 18. The at least one spray device 58 can, for example, be arranged above the upper run of the transport element 20.

Preferably, the cleaning fluid line 56 is mounted in a floating, preferably longitudinally displaceable manner with respect to the main longitudinal beam 44. Preferably, heat-induced longitudinal expansion of the cleaning fluid line 56 caused, for example, by the heated cleaning fluid can be compensated for by floatingly mounting the cleaning fluid line 56, i.e., be absorbed by the floating mounting.

The floating mounting can preferably be provided at a plurality of bearing points along the cleaning fluid line 56. The longitudinal displaceability can preferably exist with respect to a longitudinal axis of the conveyor 18.

For example, the cleaning fluid line 56 can be mounted in a floating manner via at least one hook element 60 (see FIG. 3). The at least one hook element 60 can, for example, be attached and carried on the main longitudinal beam 44 directly or via a particular boom 62. The at least one hook element 60 can be embodied, for example, as a helical or round-bent rod element.

The cleaning fluid line 56 can extend longitudinally displaceably through the at least one hook element 60. Preferably, a plurality of hook elements 60 are comprised which are arranged distributed along the cleaning fluid line 56.

The boom 62 can be connected to the main longitudinal beam 44, for example, detachably, e.g., by screw connection(s), or non-separably, e.g., by welding. Preferably, the boom 62 can extend with its main extension direction transversely to a longitudinal axis of the main longitudinal beam 44.

The at least one secondary deflection wheel 64, 66 can deflect the circulating transport element 20 (see FIGS. 2 and 5). For example, the at least one secondary deflection wheel 64, 66 can be arranged in the region of an isolator wall of an isolator/clean room in which the closure apparatus (see FIG. 1) is arranged. In the region of the at least one secondary deflection wheel 64, 66, the transport element 20 can, for example, leave the isolator in which the closure apparatus (see FIG. 1) is arranged. Preferably, the at least one secondary deflection wheel 64, 66 is arranged in a return portion of the conveyor 18 for returning the circulating transport element 20 to the main deflection wheel 38.

The transport element 20 can be placed around the at least one secondary deflection wheel 64, 66. Preferably, the at least one secondary deflection wheel 64, 66 has a horizontally oriented axis of rotation. The at least one secondary deflection wheel 64, 66 can deflect the transport element 20 such that a height level of the transport element 20 is changed, preferably increased.

For example, the at least one secondary deflection wheel 64, 66 can be a deflection pinion in engagement with the circulating transport element 20. Preferably, the at least one secondary deflection wheel 64, 66 can be a deflection sprocket (idler sprocket) in engagement with the transport element 20 designed as a transport chain.

Preferably, all deflections of the transport element 20 of the conveyor 18 are made by wheels, i.e., by the drive pulley 22, by the main deflection wheel 38 and by the at least one secondary deflection wheel 64, 66. The conveyor 18 can thus be free of stationary sliding profiles for deflecting the circulating transport element 20. Overall, this can advantageously also result in particularly smooth running of the transport element 20 and an increase in the service life of the guides and the transport element 20.

The tensioning device 68 serves to tension the circulating transport element 20 (see FIGS. 2 and 7). Preferably, the main deflection wheel 38 can be longitudinally displaceable by the tensioning device 68 for tensioning the circulating transport element 20. Preferably, the tensioning device 68 can be a pneumatic tensioning device.

Preferably, the tensioning device 68 is again carried on the main longitudinal beam 44. For example, the tensioning device 68 can be arranged and carried at one end of the main longitudinal beam 44.

For example, the tensioning device 68 has a, preferably pneumatic, pressure cylinder 70 which acts on the main deflection wheel 38 to extend along a longitudinal axis of the conveyor 18 in order to tension the circulating transport element, preferably continuously. The pressure cylinder 70 is preferably continuously pressurized with compressed air to push/pressurize the main deflection wheel 38 in a direction away from the drive pulley 22.

For example, the pressure cylinder 70, or a piston of the pressure cylinder 70, can be operatively connected to an axis of rotation of the main deflection wheel 38 for displacing the axis of rotation and thus the main deflection wheel 38. Preferably, the displacement movement takes place parallel to a longitudinal axis of the conveyor 18.

A position of the tensioning device 68 can be detected by a position sensor 72. Alternatively, the position sensor 72 can, for example, detect a position of the main deflection wheel 38. The detected position (of the tensioning device 68/the main deflection wheel 38) is preferably a longitudinal position relative to a longitudinal axis of the conveyor 18.

The position sensor 72 can detect, for example, when a reference point or a reference part of the tensioning device 68/the main deflection wheel 38 leaves a monitoring region or enters a monitoring region.

A control device can preferably monitor a functionality of the circulating transport element 20 depending on a signal output of the position sensor 72. For example, excessive elongation or a crack in the transport element 20 can be detected. The control device can, for example, operate an output device (e.g., display, loudspeaker, and/or signal light) to output information about the monitored functionality and/or stop operation of the conveyor 18 if a lack of functionality is detected (e.g., detected position outside the specified tolerance range or monitoring range).

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed and claimable independently of all of the features of independent claim 1 and, for example, independently of the features relating to the presence and/or configuration of the transport element, the carriers, the cleaning fluid line, the spray devices and/or the main longitudinal beam of independent claim 1. All ranges specified herein are to be understood as disclosed in such a way that all values falling within the relevant range are individually disclosed and claimable, e.g., also as the relevant preferred narrower outer limits of the relevant range.

List of Reference Signs

| | |
|---|---|
| 10 | container treatment facility |
| 12 | container |
| 14 | filling apparatus |
| 16 | closure apparatus |
| 18 | conveyor |
| 20 | transport element |
| 22 | drive pulley |
| 24 | drive source |
| 26 | housing |
| 28 | upper access opening |
| 30 | side access opening |
| 32 | cover |
| 34 | cover |
| 36 | machine table |
| 38 | main deflection wheel |
| 40 | carrier |
| 42 | transfer plate |
| 44 | main longitudinal beam |
| 46 | fastening-element-to-elongated-hole connection |
| 48 | fastening element |
| 50 | mounting plate |
| 52 | elongated hole |
| 54 | boom |
| 56 | cleaning fluid line |
| 58 | spray device |
| 60 | hook element |
| 62 | boom |
| 64 | secondary deflection wheel |
| 66 | secondary deflection wheel |
| 68 | tensioning device |
| 70 | pressure cylinder |
| 72 | position sensor |
| T | transport direction |

1. A conveyor for container transport for a container treatment facility, wherein the conveyor comprises:
a circulating transport element;
a plurality of carriers, wherein the plurality of carriers are arranged at a distance from one another along the circulating transport element and are attached to the circulating transport element for carrying containers along;
a cleaning fluid line for conveying cleaning fluid;
a plurality of spray devices connected to the cleaning fluid line for spraying the cleaning fluid; and
a main longitudinal beam which carries the circulating transport element and the cleaning fluid line.

2. The conveyor according to claim 1, wherein:
the cleaning fluid line is mounted in a floating manner with respect to the main longitudinal beam.

3. The conveyor according to claim 1, further comprising:
a transfer plate over which the containers can be pushed during the transport by the carriers,
wherein the transfer plate is carried by the main longitudinal beam.

4. The conveyor according to claim 3, wherein:
the transfer plate is mounted in a floating manner with respect to the main longitudinal beam.

5. The conveyor according to claim 3, wherein at least one of the following is met:
the transfer plate extends substantially along an entire conveying path of the conveyor; and
the transfer plate has a plurality of transfer plate segments which are aligned or flush with one another.

6. The conveyor according to claim 1, further comprising:
a drive pulley for driving the transport element, wherein the transport element is placed around the drive pulley;
a drive source which is drivingly connected to the drive pulley; and a sealed housing in which the drive source is arranged.

7. The conveyor according to claim 6, wherein at least one of the following is met:
the sealed housing has at least one access opening, wherein the at least one access opening is covered by a removable cover and sealed with a sealing element; and
the sealed housing is placed on a machine table in a sealed manner via a sealing element.

8. The conveyor according to claim 1, further comprising:
a main deflection wheel for deflecting the circulating transport element, wherein:
the circulating transport element is placed around the main deflection wheel; and
the main deflection wheel is arranged at an end region of the conveyor.

9. The conveyor according to claim 8, further comprising:
a tensioning device for tensioning the circulating transport element;
wherein:
the main deflection wheel is longitudinally displaceable by the tensioning device for tensioning the circulating transport element.

10. The conveyor according to claim 9, wherein at least one of the following is met:
the tensioning device is carried by the main longitudinal beam;
the tensioning device is a pneumatic tensioning device; and
the tensioning device has a pressure cylinder which acts on the main deflection wheel to extend along a longitudinal axis of the conveyor in order to tension the circulating transport element.

11. The conveyor according to claim 8, further comprising:
a position sensor for detecting a position of the tensioning device or the main deflection wheel; and
a control device which is configured to monitor a functionality of the circulating transport element depending on a signal output of the position sensor.

12. The conveyor according to claim 1, further comprising:
at least one secondary deflection wheel for deflecting the circulating transport element, wherein:
the circulating transport element is placed around the at least one secondary deflection wheel;
the at least one secondary deflection wheel is arranged in a return portion of the conveyor for returning the circulating transport element; and
the at least one secondary deflection wheel changes a height level of the circulating transport element.

13. The conveyor according to claim 1, wherein at least one of the following is met:
the main longitudinal beam is arranged centrally in the conveyor with respect to a transverse axis of the conveyor;
the main longitudinal beam is arranged between an upper run and a lower run of the conveyor;
the main longitudinal beam extends substantially along an entire length of the conveyor;
the main longitudinal beam has a plurality of main longitudinal beam segments which are aligned or flush with one another;
the main longitudinal beam is arranged at a height offset from the cleaning fluid line;
the main longitudinal beam is the only main longitudinal beam of the conveyor, the conveyor having no further main longitudinal beam parallel to the main longitudinal beam;
the main longitudinal beam is not a fluid-conducting pipeline element;
the cleaning fluid line runs substantially parallel to the main longitudinal beam; and
the conveyor is free of stationary sliding profiles for deflecting the circulating transport element.

14. A container treatment facility, wherein the container treatment facility comprises:
a first apparatus;
a second apparatus; and
a conveyor according to claim 1, wherein the conveyor is connected to the first apparatus for receiving the containers from the first apparatus and to the second apparatus for transferring the received containers to the second apparatus.

15. A method for operating a conveyor according to claim 1, wherein the method comprises:
supplying a heated cleaning fluid to the cleaning fluid line (56); and
spraying the supplied heated cleaning fluid via a plurality of spray devices (58),
wherein the method further comprises at least one of the following:
compensating for longitudinal expansion of the cleaning fluid line (56) caused by the heated cleaning fluid by floatingly mounting the cleaning fluid line (56) relative to the main longitudinal beam;
compensating for longitudinal expansion of a transfer plate (42) caused by the heated cleaning fluid, over which containers (12) are pushed by the carriers (40), by floatingly mounting the transfer plate (42) relative to the main longitudinal beam (44); and
sealing a drive source (24) of the conveyor (18) against the heated cleaning fluid by a sealed housing (26) in which the drive source (24) is arranged.

16. The conveyor according to claim 1, wherein at least one of:
the container transport is a can transport;
the circulating transport element is a transport chain;
the plurality of carriers are cantilever arms or contact fingers;
the plurality of carriers are for carrying one container at a time; and
the main longitudinal beam is tubular.

17. The conveyor according to claim 2, wherein at least one of:
the cleaning fluid line is mounted in a longitudinally displaceable manner with respect to the main longitudinal beam;
the cleaning fluid line is mounted in a floating manner with respect to the main longitudinal beam to compensate for heat-induced longitudinal expansion of the cleaning fluid line;
the cleaning fluid line is mounted in a floating manner relative to the main longitudinal beam via at least one hook element; and
the cleaning fluid line is mounted in a floating manner on a boom which is connected to the main longitudinal beam.

18. The conveyor according to claim 4, wherein at least one of:
the transfer plate is mounted in a longitudinally displaceable manner with respect to the main longitudinal beam;
the transfer plate is mounted in a floating manner with respect to the main longitudinal beam to compensate for heat-induced longitudinal expansion of the transfer plate;
the transfer plate is mounted relative to the main longitudinal beam in a floating manner relative to the main longitudinal beam by a fastening-element-to-elongated-hole connection; and
the transfer plate is mounted in a floating manner on a boom which is connected to the main longitudinal beam.

19. The conveyor according to claim 7, wherein at least one of:
the transport element is placed around the drive pulley over an angular range of 180° of the drive pulley;
the at least one access opening comprises an upper access opening and a side access opening; and
the sealing element is annular.

20. The container treatment facility according to claim 14, wherein at least one of:
the container treatment facility is a can treatment facility;
